(19) United States
(12) Patent Application Publication
(10) Pub. No.: US 2007/0020402 A1
(43) Pub. Date: Jan. 25, 2007

(54) Apparatus for removing rinse liquid and method for forming photoresist pattern using the same

(75) Inventor: Kang Jae Hyun, Gyeonggi-do (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: DONGBU ELECTRONICS CO., LTD.

(21) Appl. No.: 11/492,801

(22) Filed: Jul. 26, 2006

(30) Foreign Application Priority Data
Jul. 25, 2005 (KR) 10-2005-0067782

(51) Int. Cl. B05B 13/02; B05D 5/00

(52) U.S. Cl. 427/427.4; 118/305; 427/421.1

(57) ABSTRACT

A method for forming a photoresist pattern includes coating a photoresist on a wafer and selectively exposing the photoresist; spraying a developing liquid onto an entire upper surface of the wafer to develop the photoresist; supplying a rinse liquid onto an entire upper surface of the wafer to remove the developing liquid; fixing the wafer on a stage; and disposing a rinse liquid absorbing means on an entire upper surface of the wafer to absorb the rinse liquid.

### RELATED APPLICATION

This application is based upon and claims the benefit of priority to Korean Application No. 10-2005-0067782, filed on Jul. 26, 2005, the entire contents of which are incorporated herein by reference.

### BACKGROUND

1. Technical Field

The present invention relates to an apparatus for removing rinse liquid and a method for forming a photoresist pattern using the same.

2. Description of the Related Art

Generally, a photolithography process includes uniformly coating a photoresist on a surface of a clean and dry wafer, exposing the coated photoresist with a photomask having a predetermined pattern, removing the exposed photoresist using a developing liquid to form a photoresist pattern corresponding to the predetermined pattern on the photomask, and rinsing the remaining developing liquid using a rinse liquid.

The photoresist must be sufficiently thick to maintain an etch resistance. However, when a critical dimension (CD) of a pattern decreases to realize a higher circuit integration, the aspect ratio (depth to width) of the photoresist pattern increases, which may cause pattern collapse. In particular, when the wafer is rinsed using DI water to remove the developing liquid after the exposure, the photoresist pattern may collapse if the aspect ratio is high. Pattern collapse occurs to a great extent when the aspect ratio is more than 4 and the pattern has a size of less than 100 nm.

Hereinafter, a method for forming a photoresist pattern according to a related art will be described with reference to the accompanying drawings.

FIGS. 1A and 1B are schematic views illustrating a method for forming a photoresist pattern according to a related art.

Referring to FIG. 1A, a piece of development equipment (not numbered) for developing a photoresist pattern includes a spinning chuck 11 that rotates. A wafer 12 is mounted on an upper surface of the spinning chuck 11 through a suction force of a vacuum. FIG. 1A shows that a partially exposed photoresist film 13 is already formed on an upper surface of the wafer 12. In particular, prior to mounting the wafer 12 onto the spinning chuck 11, a photoresist film is formed on the wafer 12 and exposed with a photomask in another piece of equipment.

Then, the exposed photoresist film 13 is developed by spraying a developing liquid onto an entire upper surface of the partially exposed photoresist 13 while rotating the spinning chuck at a constant speed. As a result of the development process, the exposed portions of the photoresist 13 are developed, i.e., dissolved in the developing liquid, thus forming a photoresist pattern.

Referring to FIG. 1B, a rinse liquid 14, such as DI water is supplied to an entire upper surface of the photoresist pattern 13 so as to remove the developing liquid.

In the related art, after the photoresist 13 is exposed, the developing liquid is sprayed onto the wafer 12. After a predetermined time elapse, the rinse liquid 14 is supplied to rinse the developing liquid and the developed portion of the photoresist 13 while the spinning chuck 11 is rotated at a rapid speed, thereby removing the rinse liquid 14 and residuals.

Here, the DI water used as the rinse liquid 14 is hydrophilic. However, the photoresist 13 is made of an organic material and is hydrophobic. In other words, surface tensions of the DI water 13 and the photoresist 13 are different. As a result, when the wafer 12 is rotated to remove the DI water used as the rinse liquid 14 and residuals thereof, the DI water filled in a space portion is pulled out along wall surfaces of the photoresist 13, so that a capillarity is generated to cause the patterns of the photoresist 13 to collapse, as shown in FIG. 2.

The force imposed upon the photoresist pattern when the DI water is being removed is given by the following formula:
DP=g/R
R=S/2 cos q
F=DP×D area=(2 g cos q/S)×HD,
where DP is capillary pressure gradient, g is surface tension, R is radius of curvature, S is spacing, q is contact angle of rinse liquid on resist surface, H is height of photoresist pattern, and D is width of photoresist pattern.

FIG. 1B also shows that the direction of the force F.

### SUMMARY

Embodiments consistent with the present invention provide an apparatus for removing a rinse liquid and a method for forming a photoresist pattern using the same that substantially obviate one or more problems due to limitations and disadvantages of the related art.

For example, embodiments consistent with the present invention also provide an apparatus for removing a rinse liquid and a method for forming a photoresist pattern using the same that effectively removing the rinse liquid used for removing a developing liquid without causing the photoresist pattern to collapse.

Consistent with embodiments of the present invention, a method for forming a photoresist pattern includes coating a photoresist on a wafer and selectively exposing the photoresist; spraying a developing liquid onto an entire upper surface of the wafer to develop the photoresist; supplying a rinse liquid on an entire upper surface of the wafer to remove the developing liquid; fixing the wafer on a stage, the wafer having the photoresist pattern which is formed thereon, exposed and developed; and disposing a rinse liquid absorbing means on an entire upper surface of the wafer to absorb the rinse liquid.

Consistent with embodiments of the present invention, an apparatus for developing a photoresist pattern, comprising a stage on which a wafer is to be mounted and a means for disposing a rinse liquid absorbing means over the wafer, wherein the stage is fixed, and wherein the wafer to be mounted includes a photoresist formed thereon, the photoresist having been exposed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A and 1B are schematic views illustrating a method for forming a photoresist pattern according to a related art;

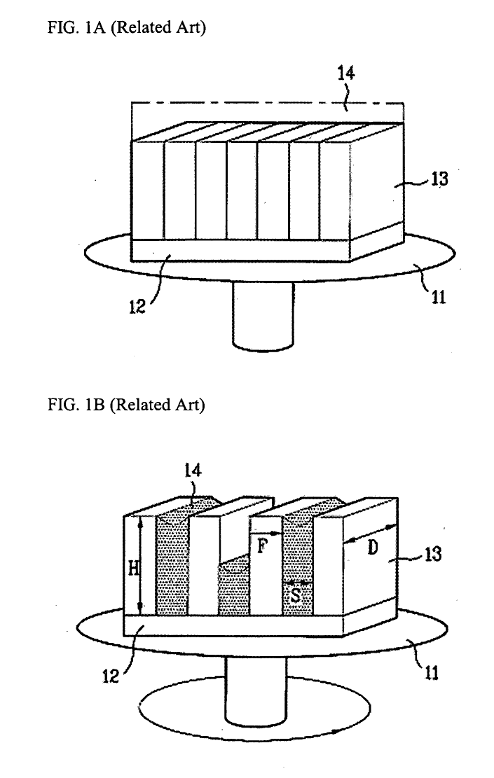

FIG. 2 is a schematic view illustrating a failure caused by removing a rinse liquid during the forming of a photoresist pattern according to a related art;

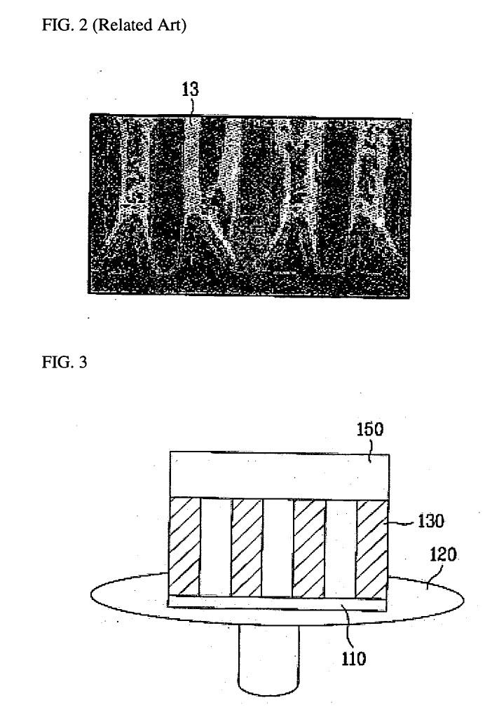

FIG. 3 is a schematic view illustrating an apparatus for removing a rinse liquid consistent with the present invention; and

FIGS. 4A through 4C are schematic views illustrating a method for forming a photoresist pattern consistent with the present invention.

### DETAILED DESCRIPTION

Reference will be made in detail to the preferred embodiments of the present invention, examples of which are illustrated in the accompanying drawings.

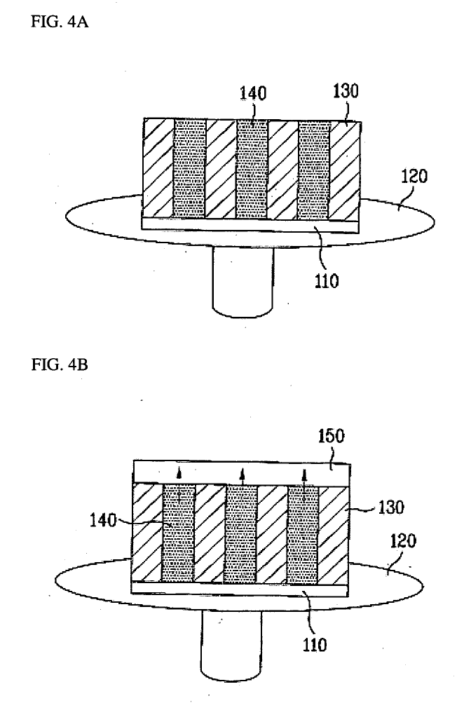

FIG. 3 is a schematic view illustrating an apparatus (not numbered) for removing a rinse liquid consistent with the present invention.

Referring to FIG. 3, the apparatus for removing a rinse liquid includes a stage 120 on which a wafer 110 is to be mounted. Prior to mounting the wafer 110 onto the stage 120, a photoresist film 130 is formed on the wafer and exposed.

The wafer 110 with the photoresist pattern 130 and the rinse liquid absorbing means 150 is mounted on the stage 120 and fixed by a vacuum force. The stage 120 is also fixed. The photoresist pattern 130 is then developed and rinsed.

Consistent with the present invention, a rinse liquid absorbing means 150 is disposed over the wafer 110 for removing rinse liquid from the photoresist 130.

The rinse liquid absorbing means 150 may comprise a super-absorbent polymer. Consistent with embodiments of the present invention, the super-absorbent polymer may comprise a monomer or a polymer, which may include carboxyl group or carboxylate group. Also consistent with embodiments of the present invention, the rinse liquid absorbing means 150 may comprise a super-absorbent polymer in the form of a thin texture or paper. Further consistent with embodiments of the present invention, the rinse liquid absorbing means 150 may include a silica gel component. The silica gel has a chemical formula of SiO₂.nH₂O and has a strong adsorptive force to the rinse liquid.

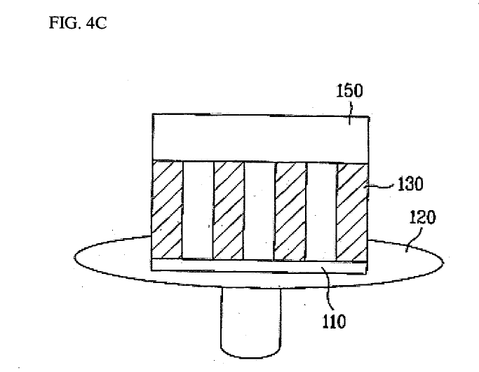

FIGS. 4A through 4C are schematic views illustrating a method for forming a photoresist pattern consistent with the present invention.

Referring to FIG. 4A, the wafer 110 having the exposed photoresist 130 is loaded and mounted on the stage 120 by a vacuum force. Thereafter, a developing liquid is sprayed onto an entire upper surface of the wafer 110 including the exposed photoresist 130. As a result of the development process, an exposed portion of the photoresist 130 is developed, i.e., dissolved in the developing liquid.

Next, a rinse liquid 140, such as DI water is supplied onto an entire upper surface of the patterned photoresist 130 so as to remove the developing liquid.

Referring to FIG. 4B, the rinse liquid absorbing means 150 of super-absorbent polymer is placed over the photoresist 130 to absorb and remove the DI water used as the rinse liquid 140, together with the developing liquid as indicated by an arrow.

Consistent with embodiments of the present invention, the process of removing the rinse liquid 140 using the rinse liquid absorbing means 150 and the process of developing the photoresist 130 can be performed in-situ, i.e., the process of removing the rinse liquid 140 can be performed in the same development equipment in which the photoresist is developed. For example, the rinse liquid absorbing means 150 may be attached to a part of the developing apparatus and lowered, or otherwise moved, into contact with the entire surface of the wafer 110.

Also consistent with embodiments of the present invention, during removing the rinse liquid 140, the rinse liquid absorbing means 150 can be disposed over the entire upper surface of the wafer 110.

In one aspect, the rinse liquid absorbing means 150 includes a super-absorbent polymer in the form of a thin texture or paper, which covers the wafer 110 and absorbs the DI water. Then, only the rinse liquid absorbing means 150 in which the DI water has been absorbed needs to be removed, thus preventing the pattern collapse phenomenon due to the capillarity associated with the technology of the related art described above.

In technology of the related art described above, the wafer 12 fixed onto the chuck 11 is rotated at a high speed to remove the DI water. However, consistent with embodiments of the present invention, the rinse liquid absorbing means 150 comprising super-absorbent means has an excellent absorbent capability. In particular, the super-absorbent resin can absorb the DI water about 1000 times as much as its weight without any external pressure or force such as rotation of a chuck. super-absorbentAs a result, the wafer 110 does not have to be rotated to remove the DI water, thereby further reducing the possibility of pattern collapse.

Referring to FIG. 4C, the rinse liquid 140 is absorbed by the rinse liquid absorbing means 150, as a result the volume of the rinse liquid absorbing means 150 increases.

Consistent with embodiments of the present invention, the rinse liquid absorbing means 150 may be removed afterwards. The rinse liquid absorbing means 150 may be efficiently removed in a lateral direction, or in any other suitable direction.

Consistent with embodiments of the present invention, after removing the rinse liquid absorbing means 150, the photoresist pattern 130 may be dried, during which any residual of the rinse liquid may be completely removed.

As described above, the apparatus for removing rinse liquid and the method for forming a photoresist pattern using the same consistent with embodiments of the present invention prevent photoresist collapse, because the wafer is mounted on the fixed stage and the rinse liquid is absorbed and removed by the rinse liquid absorbing means. As a result, the yield in fabrication of semiconductor devices increases.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for forming a photoresist pattern, comprising:
coating a photoresist on a wafer and selectively exposing the photoresist;
spraying a developing liquid onto an entire upper surface of the wafer to develop the photoresist;
supplying a rinse liquid onto an entire upper surface of the wafer to remove the developing liquid;
fixing the wafer on a stage; and
disposing a rinse liquid absorbing means on an entire upper surface of the wafer to absorb the rinse liquid.

2. The method according to claim 1, wherein disposing the rinse liquid absorbing means comprises disposing a super-absorbent polymer for absorbing and removing the rinse liquid.

3. The method according to claim 2, wherein disposing the super-absorbent polymer comprises disposing a monomer or polymer.

4. The method according to claim 2, wherein disposing the super-absorbent polymer comprises disposing a monomer or polymer having a carboxyl group or a carboxylate group.

5. The method according to claim 1, wherein disposing the rinse liquid absorbing means comprises disposing a material including a silica gel component.

6. The method according to claim 1, wherein fixing the wafer on the stage comprises fixing the wafer on the stage by a vacuum.

7. The method according to claim 1, wherein disposing the rinse liquid absorbing means and spraying the developing liquid are performed in-situ.

8. The method according to claim 1, wherein disposing the rinse liquid absorbing means comprises:
lowering the rinse liquid absorbing means with an equipment in which the spraying of the developing liquid is performed.

9. The method according to claim 1, further comprising removing the rinse liquid absorbing means including the absorbed rinse liquid.

10. The method according to claim 9, wherein removing the rinse liquid absorbing means comprises removing the rinse liquid absorbing means in a lateral direction.

11. An apparatus for developing a photoresist pattern, comprising:
a stage on which a wafer is to be mounted; and
means for disposing a rinse liquid absorbing means over the wafer,
wherein:
the stage is fixed, and
the wafer to be mounted includes a photoresist formed thereon, the photoresist having been exposed.

12. The apparatus according to claim 11, wherein the means for disposing a rinse liquid absorbing means comprises a means for disposing a super-absorbent polymer.

13. The apparatus according to claim 12, wherein the means for disposing the super-absorbent polymer comprises a means for disposing a monomer or polymer.

14. The apparatus according to claim 12, wherein the means for disposing the super-absorbent polymer comprises a means for disposing a monomer or polymer having a carboxyl group or a carboxylate group.

15. The apparatus according to claim 11, wherein the means for disposing the rinse liquid absorbing means comprises a means for disposing a material including a silica gel component.
